(19) United States
(12) Patent Application Publication
(10) Pub. No.: US 2026/0084937 A1
(43) Pub. Date: Mar. 26, 2026

(54) RECREATIONAL-CARGO-SECUREMENT STRAP AND METHODS OF USE

(71) Applicant: Optera Gear Company, LLC, Durango, CO (US)

(72) Inventor: Jackson Fisher Sandau, Durango, CO (US)

(73) Assignee: 81301-4339, Durango, CO (US)

(21) Appl. No.: 18/894,280

(22) Filed: Sep. 24, 2024

(51) Int. Cl. B66C 1/18; B66C 1/20

(52) U.S. Cl. CPC B66C 1/18; B66C 1/20

(57) ABSTRACT

The disclosures contained herein pertain to an improved recreational-cargo-securement strap that is especially adapted for use as a utility strap for the management of watercraft, such as a raft, and features three strategically disposed equipment-engagement loops.

### BACKGROUND

This invention relates to an improved recreational-cargo-securement strap that is especially adapted for use as a utility strap for the management of a raft or other watercraft, including, but not limited to, inflatable rafts, dories, wooden boats, metal boats, fiberglass boats, sail boats, paddle boards, and jet skis. Collectively, hereinafter for convenience, the aforementioned watercraft shall be generally referred to as a “Raft.”

It is common to manage a Raft in multiple situations during each use, including, e.g.:
Moving a Raft on the water without the use of oars, paddles, or a motor;
Moving a Raft on or off land or a dock;
Moving a Raft across land;
Moving a Raft on or off a transport trailer;
Securing or anchoring a Raft to a fixed point; and
Moving or freeing a Raft from an obstacle (that is, a “recovery” or “Raft-management tasks”).

The present inventive disclosures are intended to allow the above-listed tasks to be performed more easily and with less risk to a user, the Raft, and related equipment.

Historically, Raft-management tasks have been accomplished in a variety of ways: Ropes and various other cordage, cables, straps, webbing, chains, and other devices (collectively, hereinafter referred to as “Rope”) are typically used in combination with direct human-based efforts. Rope can be connected to various existing portions of a Raft, including its frame, D-rings, oar mounts/towers, raft tubes, of other fixed elements on a raft to accomplish a variety of maneuvers of the Raft and other Raft-management tasks. For example, a Rope may be connected to a D-ring of a raft on one end and to a winch line on the other end to try and help load a Raft onto a trailer. As another example, a Rope can be connected to a Raft's frame on one end and to a tree, bush, or rock along a shoreline on the other end in order to effectively anchor the Raft to shore.

Over the years, boaters have used many forms of ad hoc methods to deal with Raft-management tasks. Most of those methods are uniquely designed by individuals to the specifics of the situation, Raft, and/or other equipment. Often, the knowledge of those methods or rigging approaches are passed-down from various organizations or from local knowledge. However, the main problem with many of these approaches is that they are inefficient, pose a risk for human injury, and/or pose a risk of damage or loss of equipment. These risks result from using the wrong Rope or equipment and/or poor rigging technique. For instance, attaching a Rope to a D-ring of a Raft and applying force can cause the separation of the D-ring from the Raft under tension, resulting in damage to the Raft, a compromised situation that could in turn result in further loss of equipment and/or injury to individuals. In addition, the vast majority of these approaches do not make use of a single piece of purpose-built equipment to streamline the Raft-management tasks. For example, a Rope used to attached to a winch line to aid in the loading of the Raft onto a trailer may be too short to be effective in anchoring the raft to a shore-side anchor point.

These prior-art approaches create inefficiencies at multiple levels. Many of the Raft-management tasks are performed in sub-optimal ways in order to accommodate a single rope or other devices. This can result in unsafe situations and/or difficulty in performing certain Raft-management tasks. Moreover, boaters may be required to carry multiple pieces of equipment or rope to cover all required Raft-management tasks, which of course consumes additional space and resources on a Raft.

What is needed is a single multi-purpose device that can be easily be used and stored to facilitate the performance of most common Raft-management tasks, while also increasing the safety and efficiency for users performing various Raft-management tasks.

### BRIEF SUMMARY

The inventive disclosures contained herein pertain to an improved recreational-cargo-securement strap that is especially adapted for use as a utility strap for the management of a raft or other watercraft, including, but not limited to, inflatable rafts, dories, wooden boats, metal boats, fiberglass boats, sail boats, paddle boards, and jet skis (collectively referred to as “Rafts”). The improved recreational-cargo-securement strap can also be used to aid users in handling efforts for other types of recreational vehicles or equipment; for example, snowmobiles (also called “snow machines” in some geographical areas) can be more-easily winched-up onto a transport trailer using the improved recreational-cargo-securement strap.

In a typical application, the improved recreational-cargo-securement strap is comprised of 18 to 20 feet of heavy-duty webbing (typically rated for loads of 2000 to 4000 lbs.), though the length and load rating can be varied greatly for other applications, that features an equipment-engagement loop of webbing at each end and an equipment-engagement loop disposed substantially in the middle of the improved recreational-cargo-securement strap—and no tools are required to install and use the device. The improved recreational-cargo-securement strap specifications can be made/scaled in size to suit a variety of applications. Each of the three equipment-engagement loops can also be used in conjunction with hardware-attachment items such as carabiner; for example, a carabiner engaged with an equipment-engagement loop might be used to attach to a D-ring on a Raft.

In a typical application, the improved recreational-cargo-securement strap is attached at each of its looped ends to a fixed attachment point on each side of a Raft (for example, an oar tower on each side of the Raft, a fixed point on an aluminum superstructure frame, Raft handles, etc.), while the center-disposed equipment-engagement loop is brought forward under the Raft and engaged by a human or by a winch device to get better leverage in lifting the Raft and pulling it forward. In another common use of the improved recreational-cargo-securement strap, with the Raft launched into water, a human user can detach the center-disposed equipment-engagement loop and one of the end-disposed equipment-engagement loops to pull the Raft from the side to nestle up to a shoreline or dock, as well as to more-easily move the Raft along the shore or dock. The improved recreational-cargo-securement strap can also be used to “line” the Raft to assist the Raft through moving water with obstacles (e.g., rapids, debris, rocks, etc.) and/or Raft recovery.

The foregoing Brief Summary is intended to merely provide a short, general overview of the inventive disclosure described throughout this patent application, and therefore, is not intended to limit the scope of the inventive disclosure contained throughout the balance of this patent application, including any appended claims and drawings.

### BRIEF DESCRIPTION OF THE DRAWINGS

FIG. 1 depicts one embodiment of an overall view of an improved recreational-cargo-securement strap, with references to other Figures for more details of specific subcomponents.

FIG. 2A depicts one embodiment of one of the end-loop members of the improved recreational-cargo-securement strap shown in FIG. 1, showing the loop in a “open” configuration.

FIG. 2B depicts one embodiment of one of the end-loop members of the improved recreational-cargo-securement strap shown in FIG. 1, showing the loop from the side (that is, the aperture of the loop is not viewable, but the securement of the strapping to form the loop is shown.

FIG. 2C depicts one embodiment of one of the end loop members of the improved recreational-cargo-securement strap shown in FIG. 1, showing the loop in a “open” configuration, but with an optional mechanical attachment device (such as a carabiner) attached to the loop.

FIG. 3A depicts one embodiment of the center-loop member of the improved recreational-cargo-securement strap shown in FIG. 1, showing the loop in a “open” configuration.

FIG. 3B depicts one embodiment of center-loop member of the improved recreational-cargo-securement strap shown in FIG. 1, showing the loop from the side (that is, the aperture of the loop is not viewable and collapsed onto the strap in one direction to show the securement of the strapping on one side to form the loop is shown.

FIG. 3C depicts one embodiment of center-loop member of the improved recreational-cargo-securement strap shown in FIG. 1, showing the loop from the side (that is, the aperture of the loop is not viewable and collapsed onto the strap in the other direction (as compare to FIG. 3B) to show the securement of the strapping on one side to form the loop is shown.

FIG. 3D depicts one embodiment of the underside of the center-loop member of the improved recreational-cargo-securement strap shown in FIG. 1, showing the reinforcement member fixedly attached to the strap under the center-loop member to show the securement of the strapping to both side of the center-loop member.

FIG. 3E depicts one embodiment of the center-loop member of the improved recreational-cargo-securement strap shown in FIG. 1, showing the loop in an “open” configuration, but with an optional mechanical attachment device (such as a carabiner) attached to the loop.

FIG. 4A depicts one embodiment of the improved recreational-cargo-securement strap shown in FIG. 1 being applied on a Raft, specifically, wherein one of the end-loop members is attached to a fixed-hardware point on the Raft, in this case looped over an oar tower on the starboard-side of the Raft.

FIG. 4B depicts one embodiment of the improved recreational-cargo-securement strap shown in FIG. 1 being applied on a Raft, specifically, wherein one of the end-loop members is attached to a fixed-hardware point on the Raft, in this case looped over an oar tower on the port-side of the Raft.

FIG. 4C depicts one embodiment of the improved recreational-cargo-securement strap shown in FIG. 1 being applied on a Raft, specifically, wherein while each of the end-loop members is attached to a fixed-hardware point on each side of the Raft, the center-loop member is drawn from below the front/bow of the Raft in preparation to be attached to a winch strap.

FIG. 4D is an extension of FIG. 4C, wherein it depicts one embodiment of the improved recreational-cargo-securement strap shown in FIG. 1 being applied on a Raft, specifically, wherein while each of the end-loop members is attached to a fixed-hardware point on each side of the Raft, the center-loop member is drawn from below the front/bow of the Raft and is attached to a winch strap.

FIG. 4E is an extension of FIG. 4D, wherein it depicts one embodiment of the improved recreational-cargo-securement strap shown in FIG. 1 being applied on a Raft, specifically, wherein the center-loop member is attached to a winch strap and is beginning to be pulled-up onto a trailer.

FIG. 4F is an extension of FIG. 4E, wherein it depicts one embodiment of the improved recreational-cargo-securement strap shown in FIG. 1 being applied on a Raft, specifically, wherein the center-loop member is attached to a winch strap and is further pulled-up onto a trailer.

FIG. 4G is an extension of FIG. 4F, wherein it depicts one embodiment of the improved recreational-cargo-securement strap shown in FIG. 1 being applied on a Raft, specifically, wherein the center-loop member is attached to a winch strap and is even further pulled-up onto a trailer.

FIG. 4H is an extension of FIG. 4G, wherein it depicts one embodiment of the improved recreational-cargo-securement strap shown in FIG. 1 being applied on a Raft, specifically, wherein the center-loop member is attached to a winch strap and the Raft has been fully pulled-up onto a trailer.

### DETAILED DESCRIPTION

### I. Overview

The inventive disclosures contained herein pertain to an improved recreational-cargo-securement strap that is especially adapted for use as a utility strap for the management of a Raft. The improved recreational-cargo-securement strap can also be used to aid users in handling efforts for other types of recreational vehicles or equipment; for example, snowmobiles (also called “snow machines” in some geographical areas) can be more-easily winched-up onto a transport trailer using the improved recreational-cargo-securement strap.

In a typical application, the improved recreational-cargo-securement strap is comprised of 18 to 20 feet of heavy-duty webbing (typically rated for loads of 2000 to 4000 lbs.), though the length and load rating can be varied greatly for other applications, that features an equipment-engagement loop of webbing at each end and an equipment-engagement loop disposed substantially in the middle of the improved recreational-cargo-securement strap—and no tools are required to install and use the device. The improved recreational-cargo-securement strap specifications can be made/scaled in size to suit a variety of applications. Each of the three equipment-engagement loops can also be used in conjunction with hardware-attachment items such as carabiner; for example, a carabiner engaged with an equipment-engagement loop might be used to attach to a D-ring on a Raft.

In a typical application, the improved recreational-cargo-securement strap is attached at each of its looped ends to a fixed attachment point on each side of a Raft (for example, an oar tower on each side of the Raft, a fixed point on an aluminum superstructure frame, Raft handles, etc.), while the center-disposed equipment-engagement loop is brought forward under the Raft and engaged by a human or by a winch device to get better leverage in lifting the Raft and pulling it forward. In another common use of the improved recreational-cargo-securement strap, with the Raft launched into water, a human user can detach the center-disposed equipment-engagement loop and one of the end-disposed equipment-engagement loops to pull the Raft from the side to nestle up to a shoreline or dock, as well as to more-easily move the Raft along the shore or dock. The improved recreational-cargo-securement strap can also be used to “line” the Raft to assist the Raft through moving water with obstacles (e.g., rapids, debris, rocks, etc.) and/or Raft recovery.

### II. Terminology

The terms and phrases as indicated in quotes (“ ”) in this Section are intended to have the meaning ascribed to them in this Terminology Section applied to them throughout this document, including the claims, unless clearly indicated otherwise in context. Further, as applicable, the stated definitions are to apply, regardless of the word or phrase's case, to the singular and plural variations of the defined word or phrase.

The term “or”, as used in this specification, drawings, and any appended claims, is not meant to be exclusive; rather, the term is inclusive, meaning “either or both”.

References in the specification to “one embodiment”, “an embodiment”, “a preferred embodiment”, “an alternative embodiment”, “a variation”, “one variation”, and similar phrases mean that a particular feature, structure, or characteristic described in connection with the embodiment is included in at least an embodiment of the invention. The appearances of the phrase “in one embodiment” and/or “in one variation” and similar phrases in various places in the specification are not necessarily all meant to refer to the same embodiment.

The term “couple” or “coupled”, as used in this specification, drawings, and any appended claims, refers to either an indirect or a direct connection between the identified elements, components, or objects. Often, the manner of the coupling is related specifically to the manner in which the two coupled elements interact.

The term “removable”, “removably coupled”, “readily removable”, “readily detachable”, “detachably coupled”, and similar terms, as used in this specification, drawings, and any appended claims, refer to structures that can be uncoupled from an adjoining structure with relative ease (i.e., non-destructively and without a complicated or time-consuming process) and that can also be readily reattached or coupled to the previously adjoining structure.

Directional and/or relational terms such as, but not limited to, left, right, nadir, apex, top, bottom, vertical, horizontal, back, front, lateral, proximal, and distal are relative to each other, are dependent on the specific orientation of an applicable element or article, are used accordingly to aid in the description of the various embodiments, and are not necessarily intended to be construed as limiting in this specification, drawings, and any appended claims.

As applicable, the terms “about”, “approximately”, or “generally”, as used herein unless otherwise indicated, means a margin of +−20%. Also, as applicable, the term “substantially” as used herein unless otherwise indicated means a margin of +−10%. It is to be appreciated that not all uses of the above terms are quantifiable such that the referenced ranges can be applied.

The term “Raft” (note the initial capitalization), as used in this Specification, refers to watercraft including, but not limited to, inflatable rafts, dories, wooden boats, metal boats, fiberglass boats, sail boats, paddle boards, and jet skis.

The term “Rope” (note the initial capitalization), as used in this Specification, refers to any kind of strapping, cabling, or cordage, including, but not limited to, ropes, various other cordage, cables, straps, webbing, chains, and other devices that are typically used in combination with direct human-based efforts to help control the positioning of a Raft. A Rope can be connected to various existing portions of a Raft, including its frame, D-rings, oar mounts/towers, raft tubes, of other fixed elements on a Raft to accomplish a variety of maneuvers of the Raft and other Raft-management tasks.

The term “strap”, as used in this Specification, refers to any kind of strapping, cabling, or cordage, including, but not limited to, ropes, various other cordage, cables, straps, webbing, chains, and other devices that are typically used in combination with direct human-based efforts to help engage in Raft-management tasks.

### III. An Improved Recreational-Cargo-Securement Strap

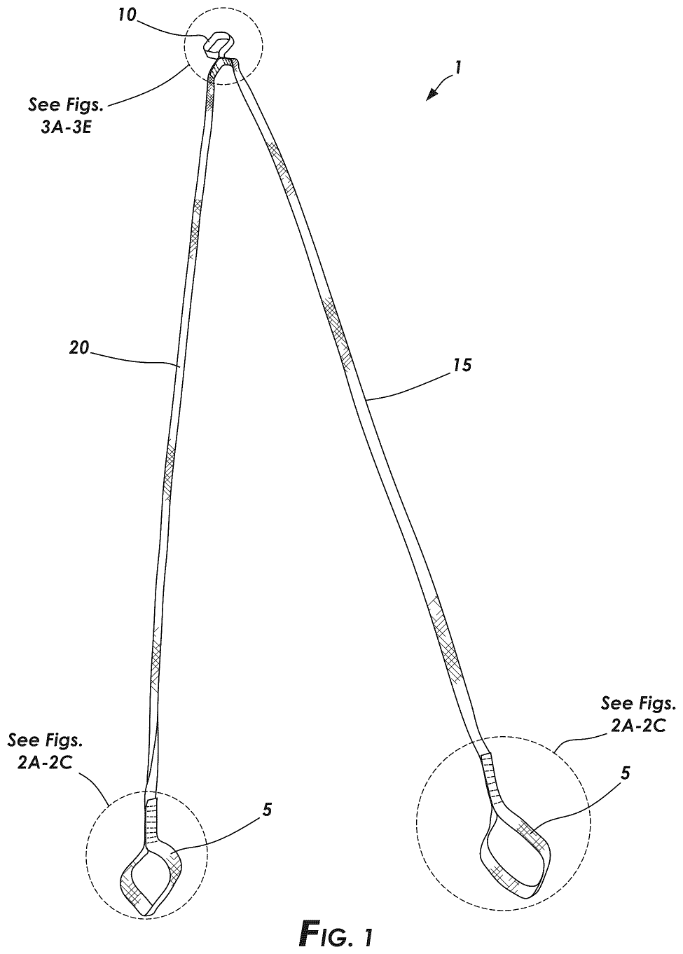

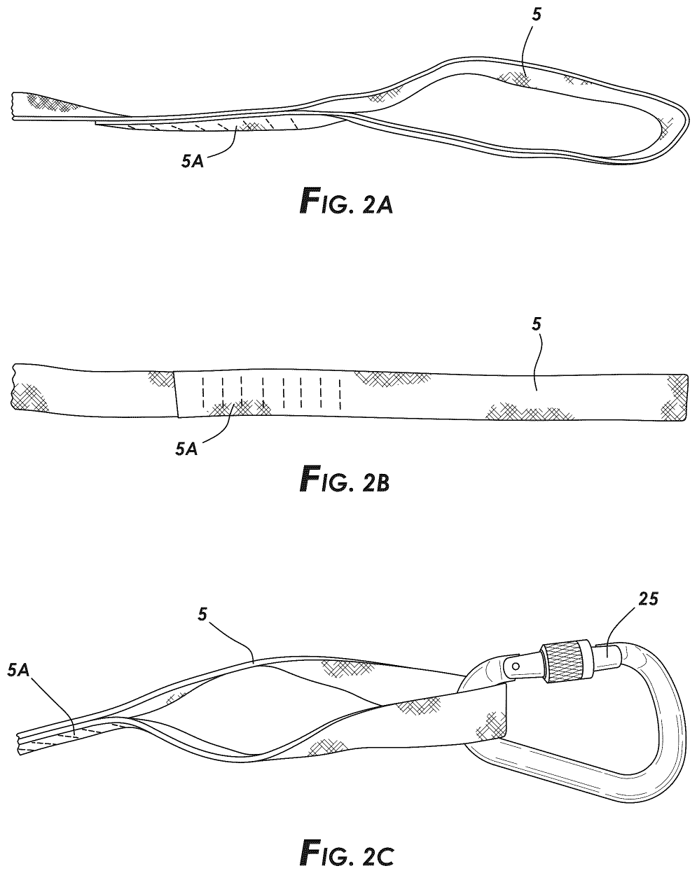

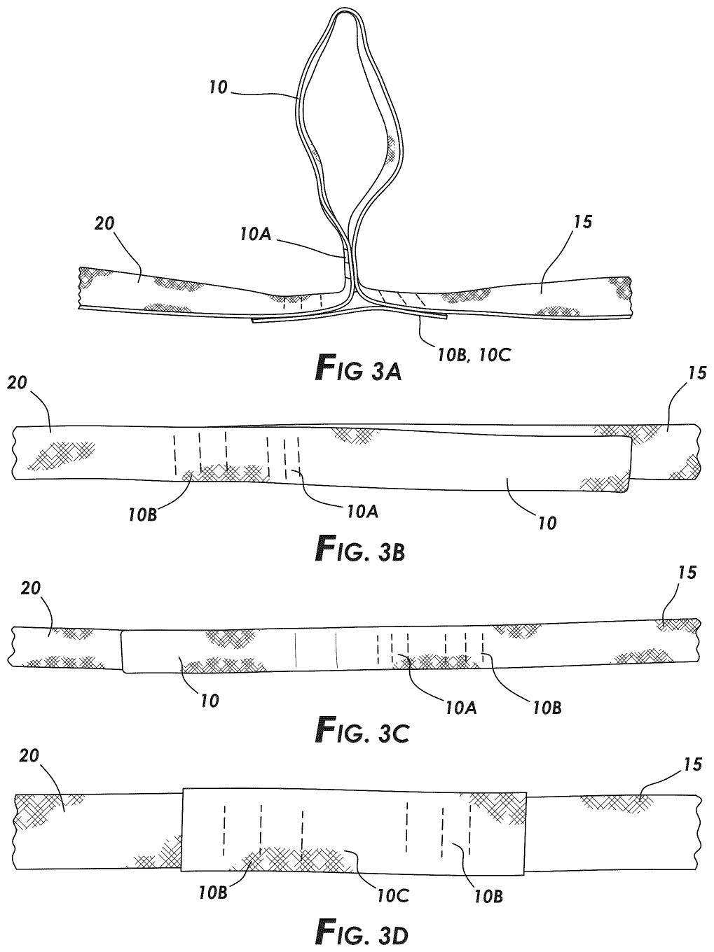

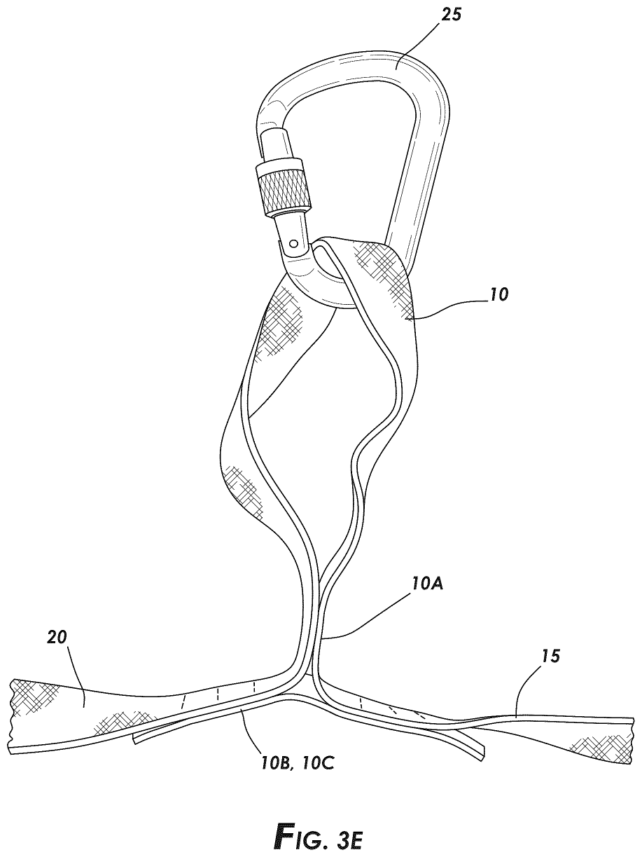

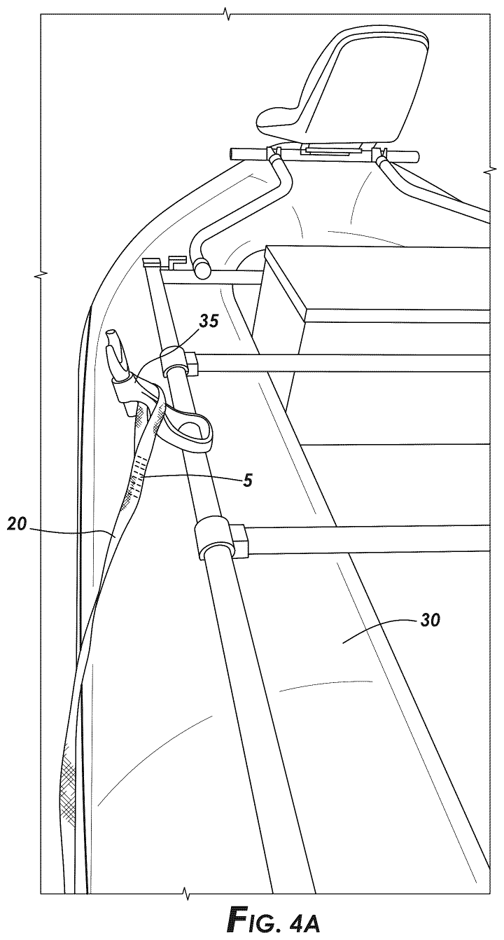

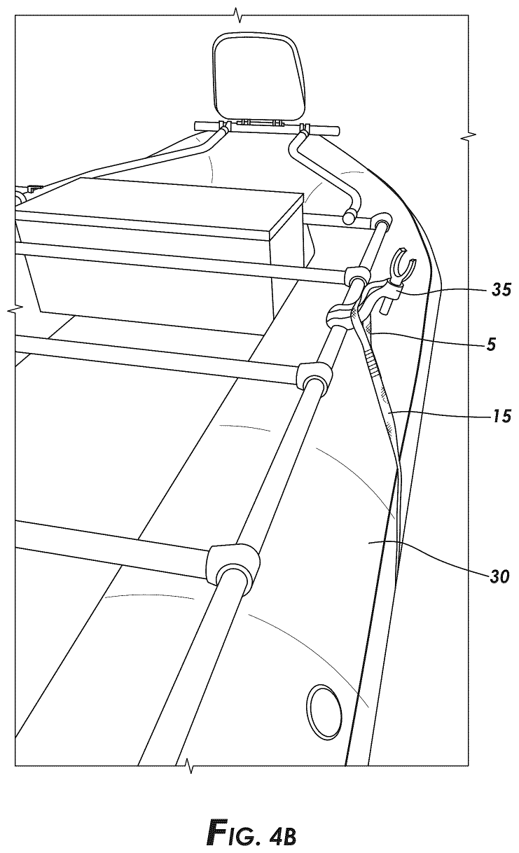

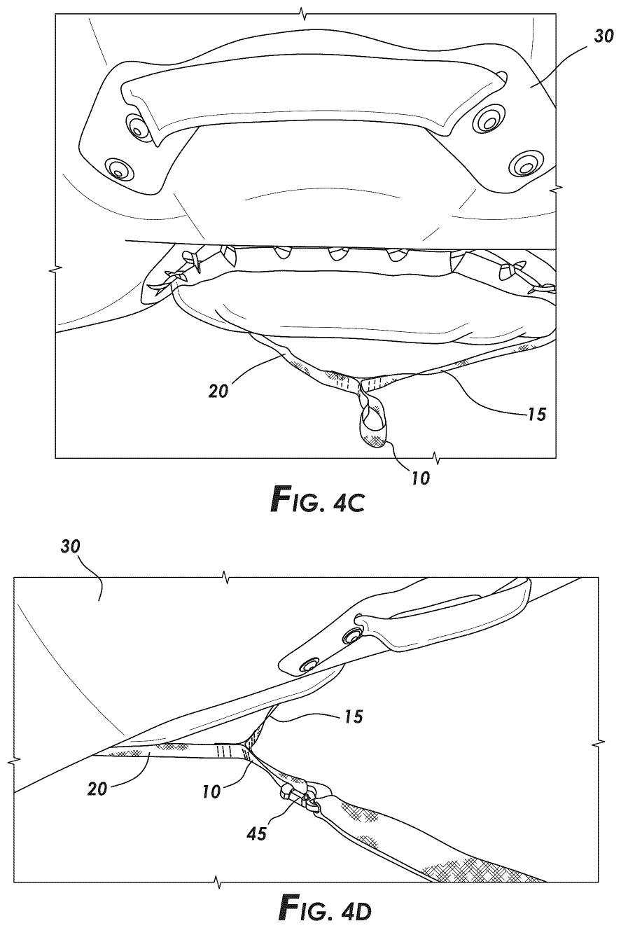

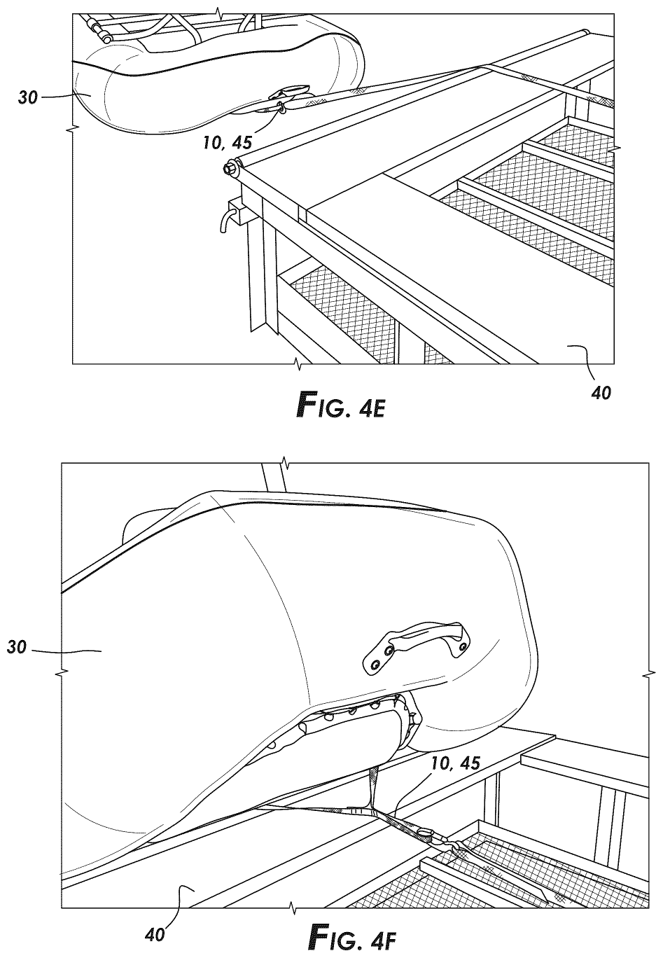

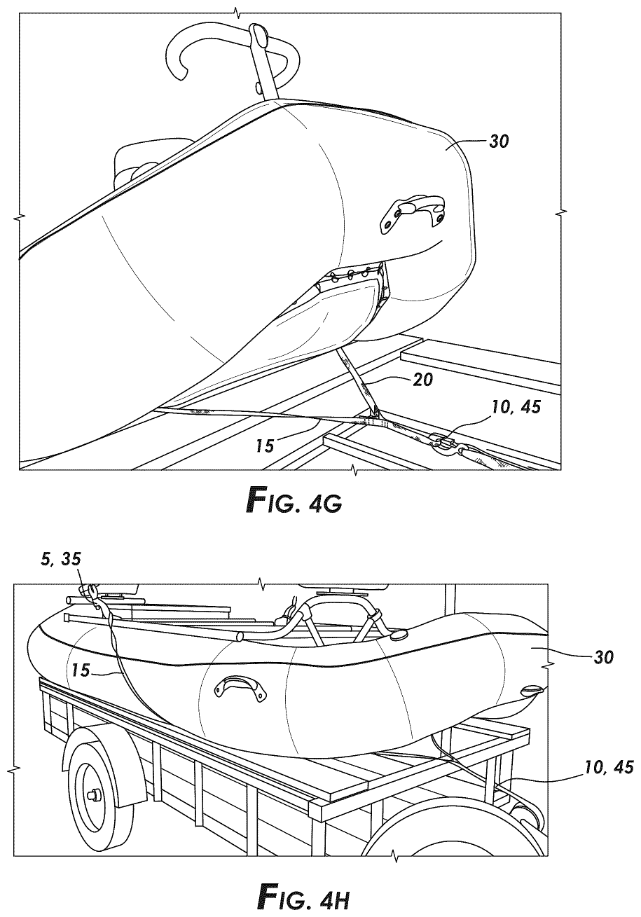

This Section III is directed generally to an improved recreational-cargo-securement strap. Refer to FIGS. 1 through 4H.

In a typical embodiment, the improved recreational-cargo-securement strap 1 is adapted for use as a utility strap for the management of a Raft 30. In many embodiments, the improved recreational-cargo-securement strap 1 is comprised of a length of heavy-duty webbing or cordage that features an equipment-engagement loop 5 at each end and an equipment-engagement loop 10 disposed substantially in the middle of the length of the improved recreational-cargo-securement strap 1, with each side of the strapping 15, 20 being approximately equal (preferably equal) in length. The improved recreational-cargo-securement strap specifications can be made/scaled in size to suit a variety of applications, but in general, the length of the improved recreational-cargo-securement strap 1 is long-enough such that when one of each equipment-engagement loop 5 is attached to a fixed point 35 on the side of the Raft 30 and the center-disposed equipment-engagement loop 10 is pulled from the bottom-front of the Raft 30, imaginary lines drawn between the three attachment points 5, 10 substantially form an Isosceles triangle.

In most preferred embodiments, the improved recreational-cargo-securement strap 1 is fabricated using 18 to 20 feet of heavy-duty webbing or cordage substantially comprised of one or more materials selected from the group consisting of nylon, polyester, polypropylene, polyurethane, ultra-high-molecular-weight polyethylene (UHMWPE), jute, and cotton. In more-complex, expensive-to-manufacture, and thus less-preferred variations, the two main lengths of strapping 15, 20 each include an incorporated winch device to allow a user to vary the length of the overall strapping. Each equipment-engagement loop 5, 10 opening is preferably sized to be large enough to allow a user to easily apply the loop over and/or with a hardware member 25, 45 to facilitate the maneuvering of a Raft. In many applications, each equipment-engagement loop 5, 10 has a circumferential opening of between 15 to 18 inches, when the loop 5, 10 is fully expanded to be opened. In variations, the heavy-duty webbing fabric is substantially coated with one or more materials selected from the group consisting of thermal-polyurethane, neoprene, rubber, and polyvinyl-chloride (PVC). In some embodiments, the improved recreational-cargo-securement strap 1 is formed from a single, continuous strap of webbing.

The improved recreational-cargo-securement strap 1 width (typically one-to-two inches in width) and load rating can be made/scaled in size to suit a variety of applications of varying load capacities. In some example embodiments, improved recreational-cargo-securement strap 1 is made according to the following non-limiting specifications:

Example Load-Capacity Specifications for An Improved Recreational-
Cargo-Securement Strap for Heavy-Duty Applications

| | | | | | | |
|---|---|---|---|---|---|---|
| Working Load (lbs.) | 1000 | 1050 | 1100 | 1250 | 1300 | 1350 |
| Breaking Strength (lbs.) | 3000 | 3200 | 3350 | 3800 | 4000 | 4100 |

In many embodiments, the equipment-engagement loops 5, 10 are formed from heavy-duty webbing by doubling-back the webbing onto itself to form a loop “neck” and securing the equipment-engagement loop 5, 10 with heavy-duty stitching 5A, 10A using thread material selected from the group consisting of bonded nylon thread, bonded polyester thread, and para-aramid synthetic fiber. In variations, this heavy-duty stitching can also include adhesives applied between fixedly coupled sections of webbing. In still-more variations, this stitching is accomplished via bar tacking for added reinforcement. In still more variations, the webbing sections forming neck of the equipment-engagement loops 5, 10 can be affixed together using metal rivets, either in combinations with the aforementioned heavy-duty stitching or by itself. In still more variations, when UHMWPE is used for the webbing/cordage, then splicing threads from the double-backed webbing/cordage is sometimes used to create the loops 5, 10.

In still more embodiments, the center-disposed equipment-engagement loop 10 is further reinforced by the use of a reinforcing strap 10C of webbing/material that is affixed as a bottom substrate to the center-disposed equipment-engagement loop 10 using heavy-duty stitching 10B using thread material selected from the group consisting of bonded nylon thread, bonded polyester thread, and para-aramid synthetic fiber. In variations, this heavy-duty stitching can also include adhesives applied between fixedly coupled sections of webbing. In still-more variations, this stitching is accomplished via bar tacking for added reinforcement. In still more variations, the reinforcing substrate 10C can be affixed to the webbing forming the base of the center-disposed equipment-engagement loop 10 using metal rivets, either in combinations with the aforementioned heavy-duty stitching or by itself.

In variations, each of the three equipment-engagement loops can also be used in conjunction with high-tensile-strength hardware-attachment items 25, 45 such as carabiner 25 (locking or unlocking type) or winch hook 45, or similar items, such as an integrated swivel As an example, a carabiner 25 engaged with an equipment-engagement loop 5 might be used to attach to a D-ring or handle on a Raft 30. Such hardware-attachment items 25 used are typically made from stainless steel, alloy steel, high-carbon steel, aluminum alloy, and carbon-fiber composite. In variations, the hardware-attachment items 25 are selected from the connector types such as carabiners, snap hooks, clip hooks, girth hitches, and the like.

In a typical usage, the improved recreational-cargo-securement strap 1 is attached at each of its equipment-engagement loops 5 to a fixed attachment point 35 on each side of a Raft 30 (for example, an oar tower 35 on each side of the Raft 30, a fixed point on an aluminum superstructure frame, Raft handles, etc.), while the center-disposed equipment-engagement loop 10 is brought forward under the Raft 30 and engaged by a human or by a winch device 45 to get better leverage in lifting the Raft 30 and pulling it forward onto a transport trailer 40.

In another common use of the improved recreational-cargo-securement strap 1, with the Raft 30 launched into water, a human user can detach the center-disposed equipment-engagement loop 10 and one of the end-disposed equipment-engagement loops 5 to pull the Raft 30 from the side to nestle up to a shoreline or dock, as well as to more-easily move the Raft 30 along the shore or dock. The improved recreational-cargo-securement strap 1 can also be used to “line” the Raft 30 to assist the Raft 30 through moving water with obstacles (e.g., rapids, debris, rocks, etc.).

Those skilled in the art will quickly recognize that the improved recreational-cargo-securement strap 1 can also be allied to various other uses, and not necessarily limited to uses with watercraft. For example, any recreational vehicle that is a bit unwieldy to lift and stow onto a transport trailer 40 can make similar use of the improved recreational-cargo-securement strap 1 so long as there are at least two fixed hardware attachment points on the sides of the recreational vehicle (such as, for example, a snowmobile) for engagement with the two end equipment-engagement loops 5 such that the center-disposed equipment-engagement loop 10 can be used to lift and pull the vehicle forward.

### IV. Alternative Embodiments and Other Variations

The various embodiments and variations thereof described herein, including the descriptions in any appended Claims and/or illustrated in the accompanying Figures, are merely exemplary and are not meant to limit the scope of the inventive disclosure. It should be appreciated that numerous variations of the invention have been contemplated as would be obvious to one of ordinary skill in the art with the benefit of this disclosure.

Hence, those ordinarily skilled in the art will have no difficulty devising myriad obvious variations and improvements to the invention, all of which are intended to be encompassed within the scope of the Description, Figures, and Claims herein.

What is claimed is:

1. An improved recreational-cargo-securement strap, comprising:
a length of strap having a first end and a second end;
an equipment-engagement loop disposed at said first end;
a second-end equipment-engagement loop disposed at said second end; and
a third equipment-engagement loop substantially disposed at the middle of said length of strap.

2. The improved recreational-cargo-securement strap of claim 1, wherein said strapping is a heavy-duty webbing or cordage.

3. The improved recreational-cargo-securement strap of claim 2, wherein said heavy-duty webbing or cordage is substantially comprised of one or more materials selected from the group consisting of nylon, polyester, polypropylene, polyurethane, ultra-high-molecular-weight polyethylene (UHMWPE), jute, and cotton.

4. The improved recreational-cargo-securement strap of claim 1, wherein said strapping is comprised of metal cable.

5. The improved recreational-cargo-securement strap of claim 1, wherein each of said equipment-engagement loops is formed from by doubling-back the strap onto itself to form a loop “neck,” then securing the double-backed strapping to itself.

6. The improved recreational-cargo-securement strap of claim 5, wherein said securement of double-backed strapping is achieved via a method selected from one or more means selected from the group consisting of heavy-duty stitching, bar tacking, adhesives, splicing, and rivets.

7. The improved recreational-cargo-securement strap of claim 6, wherein if any heavy-duty stitching is used to secure said loop neck, the heavy-duty stitching uses a material selected from the group consisting of bonded nylon thread, bonded polyester thread, ultra-high-molecular-weight polyethylene (UHMWPE), and para-aramid synthetic fiber.

8. The improved recreational-cargo-securement strap of claim 6, said third equipment-engagement loop substantially disposed at the middle of the entire length of the improved recreational-cargo-securement strap is reinforced by the use of a reinforcing strap of webbing or strap material that is affixed as a bottom substrate to said third equipment-engagement loop one or more means selected from the group consisting of heavy-duty stitching, bar tacking, adhesives, and rivets.

9. The improved recreational-cargo-securement strap of claim 8, wherein if any heavy-duty stitching is used to secure said reinforcement strap, the heavy-duty stitching uses a material selected from the group consisting of bonded nylon thread, bonded polyester thread, ultra-high-molecular-weight polyethylene (UHMWPE), and para-aramid synthetic fiber.

10. The improved recreational-cargo-securement strap of claim 1, wherein one or more of said equipment-engagement loops is coupled with a high-tensile-strength hardware-attachment item.

11. The improved recreational-cargo-securement strap of claim 10, wherein said hardware-attachment item is selected from the group consisting of a carabiner, snap hook, clip hook, integrated swivel, and winch hook.

12. A method of using an improved recreational-cargo-securement strap for use with a Raft, comprising the steps of:
obtaining an improved recreational-cargo-securement strap according to claim 1;
attaching the first end of the improved recreational-cargo-securement strap via its equipment-engagement loop to a fixed hardware point on one side of a Raft, said Raft having a front (bow) end, a rear (stern) end, a port side and a starboard side;
attaching the second end of the improved recreational-cargo-securement strap via its equipment-engagement loop to a fixed hardware point on the opposite side of the Raft, with the improved recreational-cargo-securement strap routed below the Raft;
drawing the center-disposed equipment-engagement loop forward from under the bow of the Raft; and
lifting the Raft up and forward by pulling on said center-disposed equipment-engagement loop.

13. The method of claim 12, further comprising the step of moving the Raft onto a transport trailer.

14. The method of claim 12, further comprising the step of coupling said center-disposed equipment-engagement loop with a hardware-attachment item that is itself attached to a winch.

15. The method of claim 12, further comprising the step of coupling said first-end equipment-engagement loop with a hardware-attachment item, said hardware-attachment item selected from the group consisting of a carabiner, snap hook, clip hook, and winch hook.

16. The method of claim 12, further comprising the step of coupling said second-end equipment-engagement loop with a hardware-attachment item, said hardware-attachment item selected from the group consisting of a carabiner, snap hook, clip hook, integrated swivel, and winch hook.

17. A method of using an improved recreational-cargo-securement strap for use with a Raft loaded on a transport trailer, comprising the steps of:
obtaining an improved recreational-cargo-securement strap according to claim 1;
attaching the first end of the improved recreational-cargo-securement strap via its equipment-engagement loop to a fixed hardware point on one side of a Raft, said Raft having a front (bow) end, a rear (stern) end, a port side and a starboard side;
attaching the second end of the improved recreational-cargo-securement strap via its equipment-engagement loop to a fixed hardware point on the opposite side of the Raft, with the improved recreational-cargo-securement strap routed below the Raft;
drawing the center-disposed equipment-engagement loop forward from under the bow of the Raft; and
connecting said center-disposed equipment-engagement loop to a winch installed on said transport trailer;
locating said transport trailer into a body of water;
lowering said Raft into a body of water by unwinding said winch; and
detaching said winch from said center-disposed equipment-engagement loop.

18. The method of claim 17, further comprising the steps of:
detaching one of the ends of said improved recreational-cargo-securement strap from its fixed hardware point on one side of said Raft; and
with said improved recreational-cargo-securement strap still attached to a fixed hardware point on said Raft, pull said improved recreational-cargo-securement strap from under said raft and use said improved recreational-cargo-securement strap to control said Raft along a shoreline or dock, as applicable.

19. The method of claim 17, further comprising the step of coupling said first-end equipment-engagement loop with a hardware-attachment item, said hardware-attachment item selected from the group consisting of a carabiner, snap hook, clip hook, and winch hook.

20. The method of claim 17, further comprising the step of coupling said second-end equipment-engagement loop with a hardware-attachment item, said hardware-attachment item selected from the group consisting of a carabiner, snap hook, clip hook, integrated swivel, and winch hook.
